(19) United States
(12) Patent Application Publication
(10) Pub. No.: US 2006/0111964 A1
(43) Pub. Date: May 25, 2006

(54) Project evaluation metric, methods of using the same, and programs for generating and using the metric

(76) Inventor: Richard Charles Bingham, Kennett Square, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/283,000

(22) Filed: Nov. 18, 2005

Related U.S. Application Data
(60) Provisional application No. 60/629,939, filed on Nov. 22, 2004.

(51) Int. Cl. G06F 17/30

(52) U.S. Cl. 705/10

(57) ABSTRACT

A method for evaluating projects for a product under development by generating a Project Traction Index based upon a market relevance criterion, a technical uniqueness criterion, and a plan for commercialization criterion. The Project Traction Index is functionally related to the numeric confidence level assigned to each factor considered. Each numeric confidence level is a measure of the level of confidence of the factor based upon the credibility or certainty of the sources of information used to predict the factor. The Project Traction Index may be used to prioritize respective projects or to evaluate a portfolio of projects. The numeric confidence level assigned to each factor may be used to identify problematic assumptions. A machine-readable storage medium containing a set of instructions for causing a computing device to implement the methods is also disclosed.

### CROSS-REFERENCE TO RELATED APPLICATION

This application claims priority under 35 U.S.C. §119 from U.S. Provisional Application Serial No. 60/629,939, filed Nov. 22, 2004.

### FIELD OF THE INVENTION

The subject invention is directed to a project evaluation metric for evaluating product development project(s) and to methods of using the same, and to a computer readable storage medium containing programs for generating and using the project evaluation metric.

### BACKGROUND OF THE INVENTION

Evaluation of a technical project that has as its goal the development of a new product or service is a difficult task.

It has been recognized that three broad general considerations are implicated in the evaluation of a technical project. These considerations are: (1) market relevance of the product or service proposed for development; (2) the technical uniqueness of the proposed product or service; and (3) the strategy for commercialization of the proposed product or service.

As stated by Mr. Robert Buderi in the book Engines of Tomorrow (Simon and Schuster 2000), quoting Mr. Rich Friedrich, an engineer at Hewlett-Packard Laboratories:
“I actually think corporate research is not very difficult. It all boils down to three things. You have to be relevant. You have to do something that's novel that adds value. And you've got to transfer the technology.”

It is believed that prior technical project evaluation methodologies are either too general in their treatment of these considerations to be useful or too detailed as to be burdensome. Whether general or detailed, however, prior art methodologies are believed deficient in that they accept information at face value and do not quantify the credibility of an information source.

In view of the foregoing it is believed to be desirable to provide a method and program for generating a project evaluation metric useful in the evaluation of product development project(s) that is based upon a combination of factors (derived from the broad general considerations outlined above) in which a numeric predictive value is assigned to each factor in accordance with the credibility or certainty of the sources of information relative to that factor.

### SUMMARY OF THE INVENTION

The present invention is directed to a method for generating a project evaluation metric, termed a “Project Traction Index”, useful in the evaluation of a technical project having as its goal the development of a new product or service. The term “product”, as used throughout this specification (including the claims), is to be construed to encompass either a product or a service. 15 Broadly speaking, the Project Traction Index is calculated as a functional relationship of the numeric confidence level assigned to a prediction for each of the considerations of the market relevance of the product, the technical uniqueness of the product, and the plan for commercialization of the product.

More particularly, the market relevance of the product is evaluated by assigning a predicted numeric confidence level to one or more of the following factors:

i) definition of market need for the product;

ii) definition of product attributes relevant to a consumer of the product;

iii) estimation of market profitability;

iv) estimation of obtainable market share; and

v) impact of environmental or regulatory obstacles.

The technical uniqueness of the product is evaluated by assigning a predicted numeric confidence level to one or more of the following factors:

i) estimation of technology development required to realize the product;

ii) definition of technical specifications needed to implement the product attributes;

iii) estimation of obtainable intellectual property protection;

iv) availability of customer guidance; and

v) availability of necessary technical skills.

The plan for commercialization of the product is evaluated by assigning a predicted numeric confidence level to one or more of the following factors:

i) availability of marketing and sales resources;

ii) estimation of pre-tax margin;

iii) estimation of pre-manufacturing scale-up cost;

iv) estimation of rate of customer acceptance; and

v) estimation of strength of position in value chain.

In accordance with the present invention the predicted numeric 15 confidence level for any factor is determined in accordance with a graduated scale that measures the level of confidence in the prediction or forecast based upon the credibility or certainty of the sources of information relative to that factor.

The Project Traction Index is functionally related to the numeric confidence level of each factor considered when evaluating the market relevance, the technical uniqueness and the plan for commercialization. Any of a plurality of functional relationships may be used to calculate the Project Traction Index.

In a preferred instance the factors relevant to market relevance, technical uniqueness and plan for commercialization are used in a hierarchical manner to generate a respective market relevance numeric criterion, a technical uniqueness numeric criterion, and plan for commercialization numeric criterion. These three criteria are then combined to produce the Project Traction Index.

In an alternative instance the factors relevant to the evaluation of market relevance, the technical uniqueness and the plan for commercialization may be used in a direct manner to calculate the Project Traction Index.

The present invention is also directed to a method for prioritizing respective projects for a first and a second product under development, to a method for evaluating a portfolio containing two or more product development projects, and a method for identifying problematic assumptions underlying a prediction of commercial success of a product development project.

The present invention is also directed to a machine-readable storage medium containing a set of instructions for causing a computing device to implement any of the methods of the present invention.

### BRIEF DESCRIPTION OF THE DRAWINGS

The invention will be more fully understood from the following detailed description taken in connection with the accompanying Figures, which form a part of this application and in which:

FIG. 1 is a Table illustrating the correspondence between numeric values assignable to a factor and the level of credibility or certainty of the sources of information relative to that factor; and

FIG. 2 is a Table showing the results of a plurality of functional relationships that may be used to calculate the Project Traction Index for the Examples.

### DETAILED DESCRIPTION OF THE INVENTION

The present invention is directed to an evaluation metric that may be used to form judgments regarding one or more product development project(s). Each development project may be directed to either a tangible product or a useful service, and the term “product”, as used herein, is to be construed to encompass either. The evaluation metric in accordance with the present invention is believed to provide a quantifiable, rigorous, and unbiased measure that a development project under examination will meet, or is meeting, its assigned goals and objectives. In this sense the evaluation metric provides an indication that the project is gaining or maintaining headway, or “traction”, towards these ends. The metric is, in this sense, appropriately termed the “Project Traction Index”.

The Project Traction Index is based upon a combination of factors derived from the broad general considerations discussed in the Background. These factors are relevant to a determination that a given project is likely to meets its goals and objectives, such as generating the predicted level of revenue.

The factors pertaining to the market relevance consideration may be grouped to form a market relevance criterion. Likewise, the factors relevant to the technical uniqueness may be grouped to form a technical uniqueness criterion, while the factors relevant to the plan for commercialization may be grouped to form a commercialization criterion.

Each factor is assigned a numeric confidence level value. The numeric confidence level assigned to a given factor is a measure of the level of confidence in the prediction or forecast of a factor based upon the credibility or certainty of the sources of information relative to that factor.

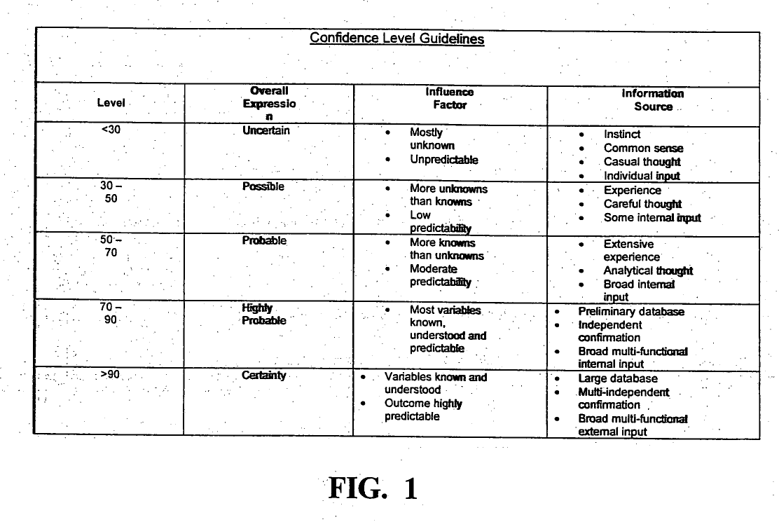

The Table in FIG. 1 shows the correspondence between a numeric confidence level (Column I) and the credibility of an Information Source (Column IV). The numeric confidence levels are arranged in ascending order to reflect the increasing credibility of the information source. The values are expressed in the range from zero to one hundred (0 to 100) and express “percentage of confidence” in the credibility of the source.

The descriptors shown in Columns II and IlIl (“Overall Expression” and “Influence Factor”, respectively) characterize, in general terms, the credibility of the source. This arrangement may be viewed to express a pyramidal arrangement in the sense that the “Information Source” is the base or primary underpinning for a numeric confidence level, while the “Influence Factor” and “Overall Expression” descriptors form secondary and tertiary levels, respectively.

For example, from examination of FIG. 1 it may be observed (in the lower right box) that, where a large database of information from a plurality of sources is available, a high numeric confidence level (i.e., a high percentage of confidence) would be assigned to a given factor (lower left box). Conversely, a relatively low numeric-confidence level (i. e., a low percentage of confidence) (upper left box) would be assigned where the factor is unknown or unpredictable, or where the source of information used to evaluate the factor is based upon instinct, common sense, or from a single individual (upper right box).

The factors derived from the broad general considerations outlined above are discussed in turn.

Market Relevance The first consideration used to formulate the Project Traction Index is market relevance. This is seen as a general measure of the likely willingness of a customer to purchase the product being developed by the project under consideration.

Market relevance is based upon one or more of the following factors:

i) definition of market need for the product (“Market Need Defined”);

ii) definition of product attributes relevant to a consumer of the product (“Attributes Required Clearly Understood”);

iii) estimation of market profitability [“Attractive Market (Size, Growth Trend)”];

iv) estimation of obtainable market share [“Attractive Share Potential (Low Competitive Intensity)”];

v) impact of environmental or regulatory obstacles (“Environmental Impact”).

The “Market Need Defined” factor (Factor Code M1) expresses an understanding of a desire of a customer for the product.

The “Attributes Required Clearly Understood” factor (Factor Code M2) expresses an understanding of the attribute(s) or characteristic(s) for the product that is(are) important to the customer.

The “Attractive Market (Size, Growth Trend)” factor (Factor Code M3) expresses an understanding around the potential magnitude of market opportunity. It includes an understanding of whether the market opportunity is large enough to justify a product development project. It includes an understanding as to whether the market is expected to have an attractive growth rate.

The “Attractive Share Potential (Low Competitive Intensity)” factor (Factor Code M4) measures the likelihood that a competitive position can be established relative the expected competition. It includes an understanding as to whether the product will become a commodity item or remain a specialty item.

The “Environmental Impact” factor (Factor Code M5) measures the extent of obstacles presented by environmental considerations or regulations of any sort. However, the factor is broader than strictly “environmental” concerns, and would include considerations of safety issues, consumer concerns and/or public perception.

Technical Uniqueness The second consideration used to formulate the Project Traction Index is technical uniqueness. This is a forecast of the general uniqueness of the product relative to other products.

Technical uniqueness is based upon one or more of the following factors:

i) estimation of technology development required to realize the product (“Technology Requirements”);

ii) definition of technical specifications needed to implement the product attributes (“Specifications Clearly Defined”);

iii) estimation of obtainable intellectual property protection (“Intellectual Property Estate”);

iv) availability of customer guidance (“Voice of the Customer Available”); and

v) availability of necessary technical skills (“Technical Skills Required”).

The “Technology Requirements” factor (Factor Code T1) expresses a forecast of technology development needed to realize the product. It includes considerations of technology already available and of technology not yet available that must be developed.

The “Specifications Clearly Defined” factor (Factor Code T2) is a forecast of considerations of the technical definition of desirable product attributes, expressed in the second factor of the market relevance criterion. It also includes measurable parameters or characteristics necessary to manufacture the product, such as manufacturing quality standards.

The “Intellectual Property Estate” factor (Factor Code T3) is a prediction of the strength of the intellectual property estate. It includes protection available under the patent, trademark, copyright, and/or trade secret laws.

The “Voice of the Customer Available” factor (Factor Code T4) is a forecast of the availability of customer input and feedback during the development process. It includes both the accessibility of the potential customer and the willingness of that customer to provide input.

The “Technical Skills Required” factor (Factor Code T5) is a forecast of the availability of employees (or outside sources) having the necessary technical skills to develop and manufacture the product.

Commercialization Plan The third consideration used to formulate the Project Traction Index is the plan for commercialization. This involves considerations of the product commercialization effort.

The commercialization plan is based upon one or more of the following factors:

i) availability of marketing and sales resources (“Marketing/Sales Resources”);

ii) estimation of pre-tax margin potential as a forecast of the difference between selling price and the total cost of goods sold (“Pre-tax Margin Estimate”);

iii) estimation of manufacturing scale-up cost (“Cost of Scale-up”);

iv) estimation of rate of customer acceptance (“Rate of Customer Acceptance”);

v) estimation of strength of position in value chain (“Value Chain Strength”).

The “Marketing/Sales Resources” factor (Factor Code C 1) expresses a forecast of the level (and availability of marketing and sales resources needed to sell the product. It includes considerations of the number of people and of any special marketing skills required.

The “Pre-tax Margin Estimate” factor (Factor Code C2) is a prediction of the pre-tax margin of the product. This prediction is based on the difference of the expected selling price and the expected cost of goods sold (the cost of manufacture plus selling costs plus overhead).

The “Cost of Scale-up” factor (Factor Code C3) is a forecast of the cost required to initiate commercially significant manufacturing activity. It includes the capital investment for facilities and equipment necessary to transition from laboratory feasibility demonstration to full-scale commercial production.

The “Rate of Customer Acceptance” factor (Factor Code C4) is a forecast of the speed of customer acceptance. It includes consideration of processes used by the customer to qualify the product.

The “Value Chain Strength” factor (Factor Code C5) is a forecast of the value capture potential of the product within the total value chain. It includes consideration of the pricing power the product is expected to have within the value chain.

CALCULATION OF THE METRIC Once the numeric confidence level for each of the factors is obtained the calculation of the Project Traction Index is relatively straightforward. The Project Traction Index is functionally related to the numeric confidence level of each factor considered when evaluating market relevance, technical uniqueness and plan for commercialization.

The calculation of the Project Traction Index may be performed either in a hierarchical manner or a direct manner.

When using the hierarchical manner a numeric criterion is first generated for each of the considerations of market relevance, technical uniqueness and plan for commercialization. The Project Traction Index is then calculated from the numeric values of these criteria. Each criterion may be calculated as an average (i.e., a mean value of the numeric values of the factors). The Project Traction Index may be calculated as an average (i.e., a mean value of the numeric values of the criteria) or as a multiplicative product of the criteria.

When using the direct manner the Project Traction Index is calculated directly from the numeric values of the confidence levels of the factors. The Project Traction Index may be calculated as an average (i.e., a mean value of the numeric confidence levels of the factors) or as a multiplicative product of the confidence levels of the factors.

Individual weights may be assigned either to the numeric confidence levels for the factors (direct manner) or to the numeric values of each criterion (hierarchical manner). When weights are assigned to the factors, the numeric value for the Project Traction Index is a weighted average (i. e., a mean of weighted factors) or a weighted multiplicative product (i. e., a multiplicative product of weighted factors). Correspondingly, when weights are assigned to each criterion, the numeric value for the Project Traction Index is a weighted average (i. e., a mean of weighted criteria) or a weighted multiplicative product (i. e., a multiplicative product of weighted criteria). The weights assigned to either the criteria or to the individual factors may be, for example, based on historical experience. If a weight is assigned a value of zero, the associated numeric value of a factor or criterion is effectively removed from the calculation of the Project Traction Index.

HIERARCHICAL MANNER In a first embodiment of the hierarchical manner (the so-called “Mean of Multiplicative Products” calculation method) a numeric value for each criterion is determined as the multiplicative product of the numeric confidence levels of its respective factors. The Project Traction Index is then calculated as the mean of the numeric values calculated for the market relevance criterion, for the technical uniqueness criterion and for the commercialization plan criterion.

In an alternate embodiment of the hierarchical manner (the so-called “Multiplicative Product of Means” calculation method) the Project Traction Index may be calculated by first calculating numeric values for the three criteria as the mean of the numeric confidence levels of their respective factors, and then calculating the Project Traction Index as the multiplicative product of the three criteria.

In yet another embodiment of the hierarchical manner (the so-called “Mean of the Weighted Criteria” calculation method) the Project Traction Index may be calculated by the steps of:

a) assigning a weight to each of the numeric values calculated for the market relevance criterion, the technical uniqueness criterion and to the commercialization plan criterion;

b) multiplying each numeric value by the respective weight to create weighted numeric values;

c) summing the weighted numeric values; and

d) dividing the sum by the total number of criteria used to produce the sum.

In still another embodiment of the hierarchical manner (the so-called “Multiplicative Products of Weighted Criteria” calculation method) the Project Traction Index is calculated by:

a) weighting each of the numeric values assigned to the market relevance criterion, to the technical uniqueness criterion and to the commercialization plan criterion by a respective weighting factor to produce a weighted criterion; and

b) multiplying together the weighted criteria. (It is again noted that if a weight is assigned a value of zero, the associated numeric value of the criterion is effectively removed from the calculation of the Project Traction Index.)

DIRECT MANNER In a first embodiment of the direct manner of calculation of the Project Traction Index (the so-called “Mean of Factors” calculation method) the Project Traction Index is calculated directly as the mean of the numeric confidence levels of the factors.

In a second embodiment of the direct manner of calculation (the so-called “Mean of Weighted Factors” calculation method) the Project Traction Index is calculated by:

a) assigning a weight to each factor considered when evaluating market relevance, technical uniqueness and plan for commercialization;

b) multiplying each numeric confidence leyel value by the respective weight to create weighted factors;

c) summing the weighted factors; and

d) dividing the sum by the total number of factors used to produce the sum.

In another alternate embodiment of the direct manner of calculation (the so-called “Multiplicative Product of Factors” calculation method) the Project Traction Index is calculated directly as the multiplicative product of the numeric confidence levels of the factors.

In yet another alternate embodiment of the direct manner of calculation (the so-called “Multiplicative Product of Weighted Factors” calculation method) the Project Traction Index is calculated by:

a) assigning a weight to each factor considered when evaluating market relevance, technical uniqueness and plan for commercialization; and

b) multiplying each numeric confidence level value by the respective weight to create weighted factors;

c) multiplying together the weighted factors. (It is again noted that if a weight is assigned a value of zero, the associated numeric confidence level of the factor is effectively removed from the calculation of the Project Traction Index.)

It should be appreciated that when using initial numeric values that have been normalized to a maximum value of 1.0, a multiplicative method of calculating a Project Traction Index will typically yield lower numeric values than a method of calculating a mean or a weighted mean. It is expected that the fifteen factors described herein will have different degrees of importance depending on the technology of the product being evaluated. The weighted methods of calculation described herein readily accommodate such differences in importance and permit introduction of the influence of historical perspective to the calculation.

USES. OF THE PROJECT TRACTION INDEX. Once formulated the Project Traction Index may be utilized in a variety of fashions.

In one instance the Project Traction Index may be used to prioritize respective projects for.a first and a second product under development. An initial potential commercial value for each of the first and second products is assigned. Typically the initial potential commercial value is determined using established techniques for calculating the net present value (“NPV”) of each project. Alternatively, although less financially rigorous, a projection of expected revenues at a given point in the future can be used.

A Project Traction Index is generated for each product as outlined above. The Project Traction Index is then used to scale the potential initial commercial value of each product to produce a discounted commercial value for that product. The projects may then be prioritized by comparing the discounted commercial values for the first and the second products under development.

Another use of the Project Traction Index is to evaluate a portfolio containing two or more product development projects.

Again, an initial potential commercial value for each of the first and second products is assigned and a Project Traction Index for each product is generated. Using the respective Project Traction Index the potential initial commercial value of each product is scaled to produce a discounted commercial value for each product. The portfolio value is determined by summing the discounted commercial values for the products.

In a related instance the numeric confidence levels assigned to one or more of the factors relating to the market relevance, to one or more of the factors relating to technical uniqueness, and to one or more of the factors relating to the plan for commercialization may be used as an internal project diagnostic tool to identify problematic assumptions underlying a prediction of commercial success of a product development project.

Although a Project Traction Index per se is not generated, problematic assumptions may be found by identifying those factors where the value of the numeric confidence level is below a predetermined threshold. The threshold may be determined a priori or may be determined by a mathematical technique used to determine outliers in a data set.

### EXAMPLES

The following hypothetical examples illustrate various aspects of the present invention. The superscripts relate the text to the table that follows each example. The first superscript (lower case lefter) identifies the sentence within the text and the subsequent superscript(s) (capital letter and number) identifies the related factor. The factors are designated by their Factor Codes previously set forth.

### Example A

^{[a, C1]} X Co is large multi-national manufacturer supplying specialty polymer materials used for interior trim applications in automobiles and aircraft. ^{[b, C1]} The X Co. marketing and sales organization has well-established skills in selling these specialty polymer materials into the automotive and aviation markets.

^{[C]}A proposal has been made to X Co management to develop and commercialize a new high temperature, readily recyclable polymeric material believed to be useful in engine compartment applications in automobiles and aircraft. ^{[d, M3]}The size and growth trend of the market for this proposed material is expected to be driven by pending fuel efficiency and environmental regulations which are mandating weight reduction and material recyclability. ^{[e, M3, C4, C2]}Only a moderate level of internal knowledge regarding these proposed regulations is available, particularly with regard to the timing of their expected adoption.

^{[f, C1]} Drawing upon expertise and experience with low temperature polymeric materials, an internal technical team has formulated laboratory- scale quantities of several candidate materials. ^{[g, T1]}These materials are high temperature variants of X Co's already commercialized low temperature polymeric materials. ^{[h, T2]}The specific preliminary technical specifications for the proposed material are based upon the technical team's admittedly limited knowledge of high temperature polymers coupled with their technical instincts.

^{[i, T3]}An evaluation of a preliminary patent and literature search by the technical team concluded that few patents and publications are of concern. ^{[I, M5]}Building upon previous experience with low temperature materials, the analytical work evaluating the temperature resistance and recyclability of the candidates has recently begun. ^{[k, M5]}Only preliminary results are available.

^{[I, M1, M3]}An external preliminary market research study indicates that the proposed polymer would-generate sales in excess of $500 million per year. ^{[m, M2]}Several of its internal marketing groups performed market research studies that reached conclusions similar to that of the external study. ^{[n, C2]}A preliminary evaluation of pricing and achievable pre-tax margin has been encouraging, although there are some unknowns.

[O, M4]Despite X Co's limited knowledge of the competitive landscape regarding high temperature polymers, the internal marketing group has concluded that only a few potential competitors exist.

[p, T4]Potential customers have confidentially provided information about their needs. ^{[q, T2, C4]}An indication of reasonably rapid product acceptance has been received, but unknowns remain until final product specifications are developed.

^{[r, C5]}X Company has a presence in other segments of the automotive value chain. ^{[s, C5]}X Co currently also produces the precursor materials and has some experience with fabricating end user parts from similar low temperature polymeric materials. ^{[t, C3]}Semi-works scale manufacturing tests suggest that existing manufacturing facilities might be adapted for manufacturing this product, but some unknowns remain to be resolved.

TABLE
Example A

| Factor | Numeric | Factual Basis |
|---|---|---|
| Code | Confidence Level | (Text Sentence) |
| M1 | 80 | l |
| M2 | 40 | m |
| M3 | 60 | d, e, l |
| M4 | 60 | o |
| M5 | 50 | j, k |
| T1 | 70 | g |
| T2 | 25 | h, q |
| T3 | 80 | i |
| T4 | 70 | p |
| T5 | 80 | f |
| C1 | 80 | a, b, f |
| C2 | 50 | e, n |
| C3 | 60 | t |
| C4 | 60 | e, q |
| C5 | 75 | r, s |

### Example B

^{a, C1]} Y Co is a specialty manufacturer supplying specialty medical garments. ^{[b, C1, M1]}The Y Co. marketing and sales organization has identified a need for a product line of comfortable garments for use by medical professionals that affords protection against communicable diseases, e.g., AIDS, SARS. ^{[c, C1, M1]}The marketing and sales organization, which is already deployed and participating in the target markets (selling garments to medical professionals), has conducted extensive market research which has been externally validated by leading experts in the field. ^{[d, T2, T4]}Focus groups have been used to determine the attributes required for the protective garment. ^{[e, T2, M5]} Regulatory action concerning a garment's ability to resist transmission of communicable diseases is anticipated.

^{[f, M3]}Since Y Co. already participates in the medical garment market the growth rate of that market is well understood. ^{[9, M3]}Large databases of direct customers and expected consumption rates already exist. ^{[h, M4]}Since buyer preferences for Y Co. brands have been validated by the focus groups an attractive market share potential is considered highly probable. ^{[i, M2, T2]}Most variables regarding product performance and certification are known since this is a technology domain that is well understood and documented, both internally and externally.

^{[j, T1]}is considered probable that the technology required to meet the target product attributes can be developed, based upon Y Co.'s broad internal experience, but significant technical challenges remain to be solved. ^{[k, T2]}A preliminary set of specifications, based on the target product attributes, has been developed. ^{[l, T3]}A strong intellectual property position is anticipated, since patent searches have revealed no prior art that would preclude a strong end use patent position. ^{[m, T4]}A large subset of potential customers is available for prototype testing, which will enable valuable customer input throughout the development process. ^{[n, T5]}y Co. has experienced technical resources, but additional skills, not currently available, may be needed.

^{o, C2]}An attractive pretax margin is probable, based on Y Co.'s broad experience in this market, but the success of the product line will ultimately be linked to the specific technical solution. ^{[p, C3]}Scale up costs are expected to be easily justified.

^{[q, M2, T1]}Preliminary assessments, based on market and technology experience, indicate variables are predictable within a reasonable range of uncertainty. ^{[r, C4]}Rate of Customer Acceptance of these new garments is considered to be highly probable, based on documented unmet needs within the existing customer base. ^{[s, C5]} Y Co.'S position within the medical garment value chain is strong and the new offering will build on this existing strength.

TABLE
Example B

| Factor | Numeric | Factual Basis |
|---|---|---|
| Code | Confidence Level | (Text Sentence) |
| M1 | 100 | b, c |
| M2 | 90 | c, i, q |
| M3 | 100 | f, g |
| M4 | 80 | h |
| M5 | 90 | e |
| T1 | 60 | j, q |
| T2 | 75 | d, e, i, k |
| T3 | 80 | l |
| T4 | 90 | d, m |
| T5 | 60 | n |
| C1 | 90 | a, b, c |
| C2 | 60 | b, o |
| C3 | 80 | p |
| C4 | 80 | r |
| C5 | 90 | s |

### Example C ^{[a, C1]}Z Co. is a manufacturer of packaging products supplied to the food distribution industry. ^{[b, T2]}A proposal has been made to Z Co. management to develop and commercialize a packaging film with decreased oxygen permeability to improve shelf life of highly perishable products, such as fruits and vegetables. ^{[c, M2]}Most product attributes for such a packaging film are known, understood, and predictable based on broad internal data. ^{[d, M1, M3]}The rapid growth of convenience packaging in the food industry creates a high market need that should yield an attractive market size, as confirmed by multiple external industry contacts. ^{[e, M4]}An attractive market share is considered probable, based on Z Co.'s extensive experience, but it is recognized that the competitive environment will be intense. ^{[f, M5}

Based upon Z Co.'s regulatory experience the most significant uncertainty appears to involve FDA food contact approval for the new film.

[g, T1]Development of the required technology is considered to be highly probable based on a preliminary data analysis. ^{[h, T2]}Specifications for oxygen. permeability have been independently confirmed with industry experts. ^{[i, T3]}A strong intellectual property position is probable, based on extensive internal experience. ^{[j, T4, C4]}A preliminary database of early adopters has been developed and will be the basis for obtaining customer feedback on product prototypes throughout the development process. ^{[k, T5]}Z Co. has extensive technical resources, but timely resource availability is only moderately predictable.

[l, C1]Pressure from other initiatives for marketing and sales resources will require new personnel to be hired. ^{[m, C1]}Approval for these new hires is considered to be probable to highly probable but not certain. ^{[n, C2]}An attractive pre-tax margin for the new packaging film is considered highly probable, based upon a preliminary data analysis. ^{[o, C3]}The probability of justifying scale-up costs to produce the new film is also high, based on broad, multifunctional internal input. ^{[p, C4]}Rate of Customer Acceptance is considered to be probable, based on extensive company experience in this market. ^{[q, C5]}Z Co. is already well positioned in the packaging value chain and it is highly probable that the new offering will further strengthen this position.

TABLE
Example C

| Factor | Numeric | Factual Basis |
|---|---|---|
| Code | Confidence Level | (Text Sentence) |
| M1 | 90 | b, d |
| M2 | 90 | c |
| M3 | 90 | d |
| M4 | 70 | e |
| M5 | 40 | f |
| T1 | 90 | g |
| T2 | 80 | b, h |
| T3 | 70 | i |
| T4 | 90 | j |
| T5 | 65 | k |
| C1 | 70 | m |
| C2 | 80 | n |
| C3 | 80 | o |
| C4 | 70 | j, p |
| C5 | 80 | q |

### Discussions and Conclusions

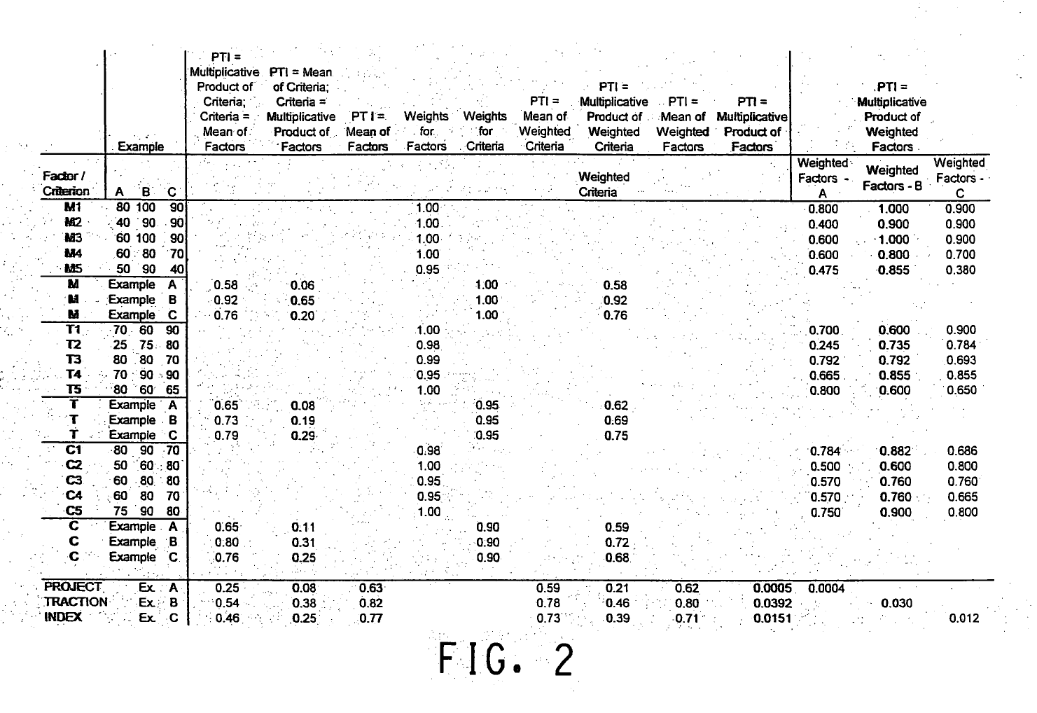

The values of numeric confidence level in the Examples are expressed as numbers in the range from zero to one hundred (0 to 100). For computational purposes these values are normalized to a range from to calculate a Project Traction Index for each product in accordance with any hierarchical or direct computational methods discussed above. The Project Traction Index (including any market relevance criterion, a technical uniqueness criterion and a plan for commercialization criterion, as the case may be) are set forth in the Table of FIG. 2. In the Table of FIG. 2, the symbols “M”, “T”, and “C” represent the market relevance criterion, the technical uniqueness criterion and the plan of commercialization criterion, respectively.

The Project Traction Index and the market relevance criterion, the technical uniqueness criterion and the plan of commercialization criterion for each of the Examples A through C calculated using the hierarchical manner Multiplicative Product of Means calculation method are summarized (after rounding to two decimal places) for further discussion in the following Summary Table.

Summary Table

| | Example | | |
|---|---|---|---|
| | A | B | C |
| Criterion | | | |
| Market Relevance | 0.58 | 0.92 | 0.76 |
| Technical Uniqueness | 0.65 | 0.73 | 0.79 |
| Commercialization Plan | 0.65 | 0.80 | 0.76 |
| Project Traction Index | 0.25 | 0.54 | 0.46 |

Prioritization It is clear that the product of Example B produces the highest Project Traction Index and that the product of Example A produces the lowest Project Traction Index.

Assuming the product of Example A has an initial potential commercial value of $100 million per year; the product of Example B has an initial potential commercial value of $75 million per year; and, the product of Example C has an initial potential commercial value of $150 million per year; then, the three projects could be prioritized by multiplying (i.e., scaling) each initial potential commercial value by its respective Project Traction Index to produce a discounted commercial value. The discounted commercial value of Example A is $25 million, Example B is $40.5 million and Example C is $69 million. Thus, the product of Example C has a higher discounted commercial value even though the product of Example B produces a higher Project Traction Index.

Portfolio Evaluation If the three examples represent a portfolio, the total discounted portfolio value is calculated by summing the discounted commercial values to produce a discounted commercial portfolio value of $74.4 million.

Problematic Assumptions To identify problematic assumptions a threshold criteria may be established and the individual numeric confidence levels of the factors then compared to the threshold.

For example, if a threshold criteria is defined as “a numeric confidence level at least 20 points lower than the next higher numeric confidence level”, it is clear that factor T2 of Example A and factor M5 of Example C meet this criteria. This conclusion indicates that additional resources should be employed in an attempt to improve the quality of information relative to these factors.

1. A method for generating a Project Traction Index for a product development project, the Project Traction Index being based upon the market relevance of the product, the technical uniqueness of the product, and the plan for commercialization of the product, the method comprising the steps of:
a) evaluating the market relevance of the product by assigning a numeric confidence level to one or more of the following factors:
i) definition of market need for the product;
ii) definition of product attributes relevant to a consumer of the product;
iii) estimation of market profitability;
iv) estimation of obtainable market share;
v) impact of environmental or regulatory obstacles;
b) evaluating the technical uniqueness of the product by assigning a numeric confidence level to one or more of the following factors:
i) estimation of technology development required to realize the product;
ii) definition of technical specifications needed to implement the product attributes;
iii) estimation of obtainable intellectual property protection;
iv) availability of customer guidance; and
v) availability of necessary technical skills;
c) evaluating the plan for commercialization of the product by assigning a numeric confidence level to one or more of the following factors:
i) availability of marketing and sales resources;
ii) estimation of pre-tax margin;
iii) estimation of pre-manufacturing scale-up cost;
iv) estimation of rate of customer acceptance; and
v) estimation of strength of position in value chain;
wherein the numeric confidence level for a factor is a measure of the level of confidence of the factor based upon the credibility or certainty of the sources of information used to predict the factor; and
d) calculating a Project Traction Index that is functionally related to the numeric confidence level of each factor considered when evaluating market relevance, technical uniqueness and plan for commercialization.

2. The method of claim 1 wherein the factors relevant to the evaluation of market relevance, the technical uniqueness and the plan for commercialization are used to generate a respective market relevance numeric criterion, a technical uniqueness numeric criterion, and plan for commercialization numeric criterion, and
wherein the Project Traction Index is based upon a combination of the three numeric criteria so generated.

3. The method of claim 2 wherein the Project Traction Index is calculated as the multiplicative product of the market relevance numeric criterion, the technical uniqueness numeric criterion and the commercialization plan numeric criterion.

4. The method of claim 3 wherein the numeric value of each respective criterion is the mean of the respective factors relevant to that criterion.

5. The method of claim 2 wherein the Project Traction Index is the mean of the market relevance numeric criterion, the technical uniqueness numeric criterion and the commercialization plan numeric criterion.

6. The method of claim 5 wherein the numeric value of each respective criterion is the mean of the respective factors relevant to that criterion.

7. The method of claim 2, wherein the Project Traction Index is calculated by:
a) assigning a weight to each of the market relevance numeric criterion, the technical uniqueness numeric criterion and the commercialization plan numeric criterion;
b) summing the weighted numeric criteria; and
c) dividing the sum by the total number of criteria used to produce the sum.

8. The method of claim 2 wherein the Project Traction Index is calculated by:
a) assigning a weight to each of the market relevance numeric criterion, the technical uniqueness numeric criterion and the commercialization plan numeric criterion; and
b) multiplying together the weighted criteria.

9. The method of claim 1 wherein the Project Traction Index is calculated as the mean of the numeric confidence level of each factor considered when evaluating market relevance, technical uniqueness and plan for commercialization.

10. The method of claim 1 wherein the Project Traction Index is calculated by
a) assigning a weight to each factor considered when evaluating market relevance, technical uniqueness and plan for commercialization;
b) multiplying each numeric confidence level value by the respective weight to create weighted factors;
c) summing the weighted factors; and
d) dividing the sum by the total number of factors used to produce the sum.

11. The method of claim 1 wherein the Project Traction Index is calculated as the multiplicative product of the numeric confidence level of each factor considered when evaluating market relevance, technical uniqueness and plan for commercialization.

12. The method of claim 1 wherein the Project Traction Index is calculated by:
a) assigning a weight to each factor considered when evaluating market relevance, technical uniqueness and plan for commercialization; and
b) multiplying each numeric confidence level value by the respective weight to create weighted factors; and
c) multiplying together the weighted factors.

13. A method for prioritizing respective projects for a first and a second product under development, the method comprising the steps of:
A) assigning an initial potential commercial value for each of the first and second products;
B) generating a Project Traction Index for each product by:
1) evaluating the market relevance of the product by assigning a numeric confidence level to one or more of the following factors:
a) definition of market need for the product;
b) definition of product attributes relevant to a consumer of the product;
c) estimation of market profitability;
d) estimation of obtainable market share; and
e) impact.of environmental or regulatory obstacles;
2) evaluating the technical uniqueness of the product by assigning. a numeric confidence level to one or more of the following factors:
a) estimation of technology development required to realize the product;
b) definition of technical specifications needed to implement the product attributes;
c) estimation of obtainable intellectual property protection;
d) availability of customer guidance; and
e) availability of necessary technical skills;
b 3) evaluating the plan for commercialization of the product by assigning a numeric confidence level to one or more of the following factors:
a) availability of marketing and sales resources;
b) estimation of pre-tax margin;
c) estimation of pre-manufacturing scale-up cost;
d) estimation of rate of customer acceptance; and
e) estimation of strength of position in value chain;
wherein the numeric confidence level for a factor is a measure of the level of confidence of the factor based upon the credibility or certainty of the sources of information used to predict the factor; and
4) calculating a Project Traction Index for each product that is functionally related to the numeric confidence level of each factor considered when evaluating market relevance, technical uniqueness and plan for commercialization;
C) using the Project Traction Index to scale the potential commercial value of each product to produce a discounted commercial value for each product; and
D) comparing the discounted commercial values for the first and the second products under development thereby to prioritize the projects.

14. A method for evaluating a portfolio containing two or more projects each for a product under development, the method comprising the steps of:
A) assigning an initial potential commercial value for the each product;
B) generating a Project Traction Index for each product by:
1) evaluating the market relevance of the product by assigning a numeric confidence level to one or more of the following factors:
a) definition of market need for the product;
b) definition of product attributes relevant to a consumer of the product;
c) estimation of market profitability;
d) estimation of obtainable market share; and
e) impact of environmental or regulatory obstacles;
2) evaluating the technical uniqueness of the product by assigning a numeric confidence level to one or more of the following factors:
a) estimation of technology development required to realize the product;
b) definition of technical specifications needed to implement the product attributes;
c) estimation of obtainable intellectual property protection;
d) availability of customer guidance; and
e) availability of necessary technical skills;
3) evaluating the plan for commercialization of the product by assigning a numeric confidence level to one or more of the following factors:
a) availability of marketing and sales resources;
b) estimation of pre-tax margin
c) estimation of pre-manufacturing scale-up cost;
d) estimation of rate of customer acceptance; and
e) estimation of strength of position in value chain;
wherein the numeric confidence level for a factor is a measure of the level of confidence of the factor based upon the credibility or certainty of the sources of information used to predict the factor; and
4) calculating a Project Traction Index for each product that is functionally related to the numeric confidence level of each factor considered when evaluating market relevance, technical uniqueness and plan for commercialization;
C) using the Project Traction Index to scale the potential commercial value of each product to produce a discounted commercial value for each product; and
D) summing the discounted commercial values for each product thereby to produce a discounted commercial value of the portfolio.

15. A method for identifying problematic assumptions underlying a prediction of commercial success of a development project for a product, the method comprising the steps of:
a) assigning a numeric confidence level to one or more of the following factors relating to the market relevance of the product:
i) definition of market need for the product;
ii) definition of product attributes relevant to a consumer of the product;
iii) estimation of market profitability;
iv) estimation of obtainable market share; and
v) impact of environmental or regulatory obstacles;
b) assigning a numeric confidence level to one or more of the following factors relating to the technical uniqueness of the product:
i) estimation of technology development required to realize the product;
ii) definition of technical specifications needed to implement the product attributes;
iii) estimation of obtainable intellectual property protection;
iv) availability of customer guidance; and
v) availability of necessary technical skills;
c) assigning a numeric confidence level to one or more of the following factors relating to a plan for commercialization of the product:
i) availability of marketing and sales resources;
ii) estimation of pre-tax margin
iii) estimation of pre-manufacturing scale-up cost;
iv) estimation of rate of customer acceptance; and
v) estimation of strength of position in value chain;
wherein the numeric confidence level for a factor is a measure of the level of confidence of the credibility of the sources of information relevant to the factor; and
d) identifying one or more factors wherein the numeric confidence level is below a threshold.

16. The method of claim 15 wherein the threshold is determined by a mathematical technique used to determine outliers in a data set.

17. A machine-readable storage medium containing a set of instructions for causing a computing device to generate a Project Traction Index for a product development project, the Project Traction Index being based upon the market relevance of the product, the technical uniqueness of the product, and the plan for commercialization of the product, said instructions comprising the steps of:
a) evaluating the market relevance of the product by assigning a numeric confidence level to one or more of the following factors:
i) definition of market need for the product;
ii) definition of product attributes relevant to a consumer of the product;
iii) estimation of market profitability;
iv) estimation of obtainable market share; and
v) impact of environmental or regulatory obstacles;
b) evaluating the technical uniqueness of the product by assigning a numeric confidence level to one or more of the following factors:
i) estimation of technology development required to realize the product;
ii) definition of technical specifications needed to implement the product attributes;
iii) estimation of obtainable intellectual property protection;
iv) availability of customer guidance; and
v) availability of necessary technical skills;
c) evaluating the plan for commercialization of the product by assigning a numeric confidence level to one or more of the following factors:
i) availability of marketing and sales resources;
ii) estimation of pre-tax margin;
iii) estimation of pre-manufacturing scale-up cost;
iv) estimation of rate of customer acceptance; and
v) estimation of strength of position in value chain;
wherein the numeric confidence level for a factor is a measure of the level of confidence of the factor based upon the credibility or certainty of the sources of information used to predict the factor; and
d) calculating a Project Traction Index that is functionally related to the numeric confidence level of each factor considered when evaluating market relevance, technical uniqueness and plan for commercialization.

18. A machine-readable storage medium.containing a set of instructions for causing a computing device to prioritize respective product development projects for a first and a second product under development, said instructions comprising the steps of:
A) assigning an initial potential commercial value for each of the first and second products;
B) generating a Project Traction Index for each product by:
1) evaluating the market relevance of the product by assigning a numeric confidence level to one or more of the following factors:
a) definition of market need for the product;
b) definition of product attributes relevant to a consumer of the product;
c) estimation of market profitability;
d) estimation of obtainable market share; and
e) impact of environmental or regulatory obstacles;
2) evaluating the technical uniqueness of the product by assigning a numeric confidence level to one or more of the following factors:
a) estimation of technology development required to realize the product;
b) definition of technical specifications needed to implement the product attributes;
c) estimation of obtainable intellectual property protection;
d) availability of customer guidance; and
e) availability of necessary technical skills;
3) evaluating the plan for commercialization of the product by assigning a numeric confidence level to one or more of the following factors:
a) availability of marketing and sales resources;
b) estimation of pre-tax margin
c) estimation of pre-manufacturing scale-up cost;
d) estimation of rate of customer acceptance; and
e) estimation of strength of position in value chain;
wherein the numeric confidence level for a factor is a measure of the level of confidence of the factor based upon the credibility or certainty of the sources of information used to predict the factor; and
4) calculating a Project Traction Index for each product that is functionally related to the numeric confidence level of each factor considered when evaluating market relevance, technical uniqueness and plan for commercialization;
C) using the Project Traction Index to scale the potential commercial value for each product to produce a discounted commercial value for each product; and
D) comparing the discounted commercial values for the first and the second products under development thereby to prioritize the projects.

19. A machine-readable storage medium containing a set of instructions for causing a computing device to evaluate a portfolio containing two or more projects each for a product under development, said instructions comprising the steps of:
A) assigning an initial potential commercial value for the each product;
B) generating a Project Traction Index for each product by:
1) evaluating the market relevance of the product by assigning a numeric confidence level to one or more of the following factors:
a) definition of market need for the product;
b) definition of product attributes relevant to a consumer of the product;
c) estimation of market profitability;
d) estimation of obtainable market share; and
e) impact of environmental or regulatory obstacles;
2) evaluating the technical uniqueness of the product by assigning a numeric confidence level to one or more of the following factors:
a) estimation of technology development required to realize the product;
b) definition of technical specifications needed to implement the product attributes;
c) estimation of obtainable intellectual property. protection;
d) availability of customer guidance; and
e) availability of necessary technical skills;
3) evaluating the plan for commercialization of the product by assigning a numeric confidence level to one or more of the following factors:
a) availability of marketing and sales resources;
b) estimation of pre-tax margin
c) estimation of pre-manufacturing scale-up cost;
d) estimation of rate of customer acceptance; and
e) estimation of strength of position in value chain;
wherein the numeric confidence level for a factor is a measure of the level of confidence of the factor based upon the credibility or certainty of the sources of information used to predict the factor; and
4) calculating a Project Traction Index for each product that is functionally related to the numeric confidence level of each factor considered when evaluating market relevance, technical uniqueness and plan for commercialization;
C) using the Project Traction Index to scale the potential commercial value of each product to produce a discounted commercial value; and
D) summing the discounted commercial values for each product thereby to produce a discounted commercial value of the portfolio.

20. A machine-readable storage medium containing a set of instructions for causing a computing device to identify problematic assumptions underlying a prediction of commercial success of a product development project, said instructions comprising the steps of:
a) assigning a numeric confidence level to one or more of the following factors relating to the market relevance of the product:
i) definition of market need for the product;
ii) definition of product attributes relevant to a consumer of the product;
iii) estimation of market profitability;
iv) estimation of obtainable market share; and
v) impact of environmental or regulatory obstacles;
b) assigning a numeric confidence level to one or more of the following factors relating to the technical uniqueness of the product:
i) estimation of technology development required to realize the product;
ii) definition of technical specifications needed to implement the product attributes;
iii) estimation of obtainable intellectual property protection;
iv) availability of customer guidance; and
v) availability of necessary technical skills;
c) assigning a numeric confidence level to one or more of the following factors relating to a plan for commercialization of the product:
i) availability of marketing and sales resources;
ii) estimation of pre-tax margin
iii) estimation of pre-manufacturing scale-up cost;
iv) estimation of rate of customer acceptance; and
v) estimation of strength of position in value chain;
wherein the numeric confidence level for a factor is a measure of the level of confidence of the factor based upon the credibility or certainty of the sources of information used to predict the factor; and
d) identifying one or more factors wherein the numeric confidence level is below a threshold.

21. The machine-readable storage medium of claim 20 wherein the threshold is determined by a mathematical technique used to determine outliers in a data set.

22. A method for generating a Project Traction Index for a product development project for a product, the Project Traction Index being based upon the market relevance of the product, the technical uniqueness of the product, and the plan for commercialization of the product, the method comprising the steps of:
a) assigning a numeric confidence level to a predicted market relevance of the product;
b) assigning a numeric confidence level to a predicted technical uniqueness of the product;
c) assigning a numeric confidence level to a predicted plan for commercialization of the product;
wherein the numeric confidence level is a measure of the level of confidence in each prediction; and
d) calculating a Project Traction Index that is functionally related to the numeric confidence level assigned to the market relevance, technical uniqueness and plan for commercialization.

23. The method of claim 22 further comprising the steps of: assigning an initial potential commercial value for the product; and using the Project Traction Index to scale the potential commercial value of the product to produce a discounted commercial value for the product.

24. The method of claim 22 for generating a Project Traction Index for a second product development project for a second product, the method further comprising the steps of:
e) assigning a numeric confidence level to a predicted market relevance of the second product;
f) assigning a numeric confidence level to a predicted technical uniqueness of the second product;
g) assigning a numeric confidence level to a predicted plan for commercialization of the second product;
wherein the numeric confidence level is a measure of the level of confidence in each prediction;
h) calculating a Project Traction Index for the second product that is functionally related to the numeric confidence level assigned to the market relevance, technical uniqueness and plan for commercialization for the second product; and
i) comparing the first product development project with the second product development project based upon their respective Project Traction Indices.

25. A machine-readable storage medium containing a set of instructions for causing a computing device to generate a Project Traction Index for a product development project for a product, the Project Traction Index being based upon the market relevance of the product, the technical uniqueness of the product, and the plan for commercialization of the product, said instructions comprising the steps of:
a) assigning a numeric confidence level to a predicted market relevance of the product;
b) assigning a numeric confidence level to a predicted technical uniqueness of the product;
c) assigning a numeric confidence level to a predicted plan for commercialization of the product;
wherein the numeric confidence level is a measure of the level of confidence in each prediction; and
d) calculating a Project Traction Index that is functionally related to the numeric confidence level assigned to the market relevance, technical uniqueness and plan for commercialization.

26. The machine-readable storage medium of claim 25 further comprising the steps of:
assigning an initial potential commercial value for the product; and using the Project Traction Index to scale the potential commercial value of the product to produce a discounted commercial value for the product.

27. The machine-readable storage medium of claim 25 containing a set of instructions for causing a computing device for generating a Project Traction Index for a second product development project for a second product, the method further comprising the steps of:
e) assigning a numeric confidence level to a predicted market relevance of the second product;
f) assigning a numeric confidence level to a predicted technical uniqueness of the second product;
g) assigning a numeric confidence level to a predicted plan for commercialization of the second product;
wherein the numeric confidence level is a measure of the level of confidence in each prediction;
h) calculating a Project Traction Index for the second product that is functionally related to the numeric confidence level assigned to the market relevance, technical uniqueness and plan for commercialization for the second product; and
i) comparing the first product development project with the second product development project based upon their respective Project Traction Indices.
